(19) United States
(12) Patent Application Publication
(10) Pub. No.: US 2005/0116002 A1
(43) Pub. Date: Jun. 2, 2005

(54) LOAD CARRIER

(75) Inventors: Magnus FERMAN, Varnamo (SE); Magnus RAGNARSSON, Varnamo (SE)

Correspondence Address: NOVAK DRUCE DELUCA & QUIGG, LLP, 1300 EYE STREET NW, SUITE 400 EAST, WASHINGTON, DC, 20005, US

(73) Assignee: THULE SWEDEN AB, Hillerstorp (SE)

(21) Appl. No.: 10/905,516

(22) Filed: Jan. 7, 2005

Related U.S. Application Data
(63) Continuation of application No. PCT/SE03/01151, filed on Jul. 2, 2003.

(30) Foreign Application Priority Data
Jul. 8, 2002 (SE) 0202121-0

(51) Int. Cl. A45F 3/14; B60R 9/00; B60R 11/00

(52) U.S. Cl. 224/497; 224/493; 224/500; 224/532

(57) ABSTRACT

A load carrier (1) for transporting bicycles that is designed, by means of a coupling device (3), to be mounted on a vehicle. The load carrier includes a carrier frame (2) with a loading surface (9) on which the bicycles to be transported are loaded, wherein the carrier frame has a carrier body (6) to which a first and a second side frame (7, 8) are attached in a foldable manner by folding devices (10, 11). The side frames, together with the carrier body form the carrier frame upon which the front and rear wheels of a loaded bicycle are placed. The side frames can be folded inward from respective extended positions in which they form the loading surface into a folded position in which they are located essentially over and on the carrier body wherein the folding device (11), for at least one of the side frames (8), incorporates a hinged arrangement (12) whose hinge pin (14) is located at an offset distance (B) from the side (13) of the carrier body (6) facing the side frame (8).

### CROSS-REFERENCE TO RELATED APPLICATIONS

The present application is a continuation patent application of International Application No. PCT/SE03/01151 filed 2 Jul. 2003 which was published in English pursuant to Article 21(2) of the Patent Cooperation Treaty, and which claims priority to Swedish Application No. 0202121-0 filed 8 Jul. 2002. Said applications are expressly incorporated herein by reference in their entireties.

### FIELD OF THE INVENTION

The present invention relates to a load carrier for transporting bicycles and which is designed, by means of a coupling device, to be mounted on a vehicle. The load carrier includes a carrier frame with a loading surface on which the bicycles to be transported are loaded. The carrier frame comprises a carrier body to which first and second side frames are respectively attached in a foldable manner by folding devices. The side frames, together with the carrier body, form the carrier frame upon which the front and rear wheels of a loaded bicycle are placed. The side frames can be folded inward from an extended position in which they form the loading surface to a folded position in which they are located essentially over and on the carrier body.

### BACKGROUND OF THE INVENTION

Load carriers of the type described above are known in the industry. A related disadvantage, however, of these types of known load carriers is that the width of the side frames, relative to the carrier body, is such that the side frames overlap when folded inward and therefore cannot be folded compactly. This results in the load carrier being bulky, for storage purposes, when not in use. To overcome this problem, it has been proposed that the width of the side frames should be reduced so that they do not overlap when folded inward. In certain cases, however, the result has been that the space available on the side frames for the wheels of the loaded bicycle is insufficient. It has also been proposed that the carrier body should be made wider relative to the side frames; this, however, has prevented certain bicycles from being accommodated (loaded on the carrier) due to the resultant increased distance between the side frames.

In U.S. Pat. No. 4,875,608, the problem has been solved by making the depth of the side frames less than that of the carrier body. This permits at least one of the side frames, when folded inward, to be folded into the carrier body and thereby affording a relatively compact-when-folded arrangement. The disadvantage of this design, however, is that the carrier body must, in terms of depth, be over-dimensioned relative to what is required to transport a given number of bicycles, and this results in unnecessary construction material usage and makes the carrier body unstable.

Therefore, a need exists for a foldable bicycle carrier in which the side frames are of such width relative to the carrier body that the wheels of a loaded bicycle are afforded sufficient room on the side frames and in which the width of the carrier body is not such that the distance between the side frames is excessive, and in which the side frames can be folded inward without overlapping and the carrier body does not require to be over-dimensioned.

### SUMMARY OF THE INVENTION

The present invention affords a solution to the above related disadvantages associated with known solutions by providing for a load carrier of the type described in the introduction above, and which is characterised by the fact that the folding device for at least one of the side frames incorporates a hinged arrangement in which the hinge pin is offset with respect to the side of the carrier body facing the side frame.

According to the invention, the hinge pin is further characterised by the fact that the offset is between approximately 0.5 and four inches (1 and 10 centimetres).

The present invention is further characterised by the fact that the hinged arrangement comprises (includes, but is not necessarily limited to) a pivot pin attached to the carrier body and a pivot plate attached to the side frame. The pivot plate is provided with an elongate hole whose longitudinal direction (axis) is lateral with respect to the longitudinal direction (axis) of the hinge pin thereby enabling the side frame to be moved sideways relative to the carrier body when the side frames are folded into a position in which they are located over the carrier body.

Finally the present invention is characterised in that the elongate hole in the pivot plate is between approximately 0.5 and four inches (1 and 10 centimetres).

### BRIEF DESCRIPTION OF THE DRAWINGS

Hereinafter, the invention is exemplarily described with reference to the accompanying figures, in which:

FIG. 1 is a perspective view of an illustrative load carrier configured in accordance with the teachings of the present invention;

FIG. 2 is a perspective view of the load carrier showing one of the side frames folded inwardly;

FIG. 3 is a perspective view of the load carrier showing both of the side frames folded inwardly;

FIG. 4 is a detail perspective view of a folding device in a position in which the side frame is extended;

FIG. 5 is a perspective view corresponding to that shown in FIG. 4, but in which the side frame is shown being inwardly folded;

FIG. 6 is a perspective view in which the side frame has been folded further inward compared with FIG. 5;

FIG. 7 is a perspective view in which the side frame has been folded fully inward and moved sideways on the support frame;

FIG. 8 is a detail view of a hinged arrangement incorporated in the invention, with the side frame in the extended position; and

FIG. 9 is a detail view corresponding to FIG. 8 in which the side frame is in the folded position.

### DETAILED DESCRIPTION OF PREFERRED EMBODIMENT(S)

FIG. 1 shows a load carrier 1 incorporating a carrier frame 2, a coupling device 3 for mounting the load carrier on a vehicle (not shown in the figure) and a support arch 4. The support arch 4 is provided with retaining arms designed for attachment to parts of the frames of the bicycles (not shown) loaded on the carrier to secure them in the loaded position. The carrier frame 2 incorporates a carrier body 6 and a first side frame 7 and a second side frame 8. In FIG. 1, the side frames are shown in the extended position, forming a loading surface 9 together with the carrier body. The side frames 7 and 8 are connected to the carrier body 6 by folding devices 10 and 11, respectively. Although the figures show two folding devices 10 and two folding device 11, it will be clear to one skilled in the art that the folding devices may be one or more in number, depending on how they are positioned on the carrier frame parts.

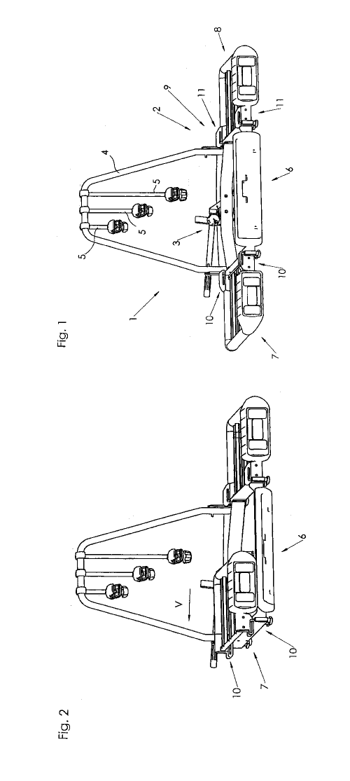

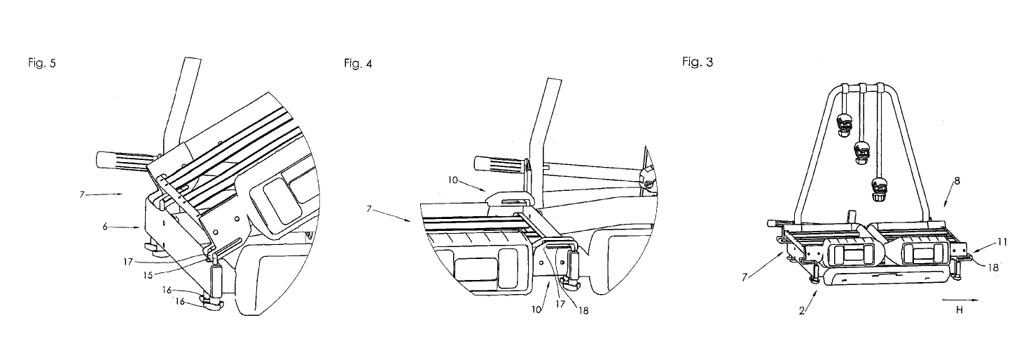

In FIG. 2, the first side frame 7 is folded inward about the folding device 10 and in FIG. 3 the second side frame 8 is also folded inward about the folding device 11, and as shown, the side frames 7 and 8 do not overlap and the load carrier 2 is folded compactly.

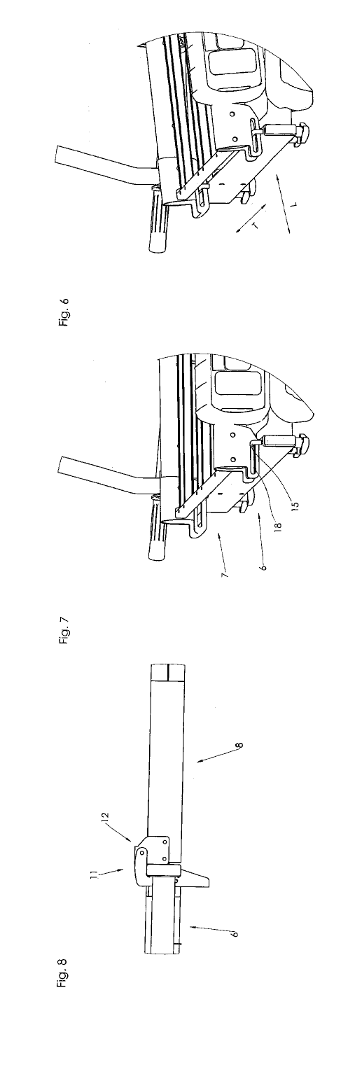

The folding devices incorporated in the present invention will hereinafter be described in greater detail with reference to FIGS. 4-9.

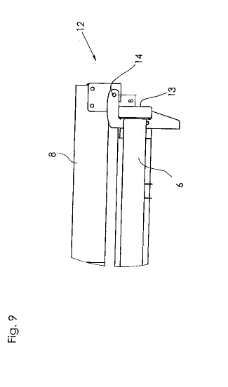

FIGS. 8-9 show a folding device 11 that incorporates a hinged arrangement 12. Although the figures show the folding device 11, it will be clear to one skilled in the art that the description is equally applicable to the folding device 10, which is a mirror image of the folding device 11. The figures schematically disclose the carrier body 6 and side frame 8, and as shown the side frame 8 is connected to the carrier body by the hinged arrangement 12. The side of the carrier body facing the side frame 8 is designated 13 and the hinge pin of the hinged arrangement is designated 14. The hinge pin is offset by a distance B from the side 13. As will be clear to one skilled in the art, this location of the hinge pin causes the side frame 8, when folded, to be sideways displaced relative to the carrier body 6 in the direction indicated by the arrow H in FIG. 3 in the same manner as though the side frame were moved sideways on the carrier body as will be described bellow in connection with FIGS. 4-7. The sideways displacement of the side frame creates sufficient space on the carrier body 6 to permit the side frames to be folded without overlapping. The invention functions well if one side frame is connected to the carrier body by a hinged arrangement of the type described above, but the offset B can be made shorter if both side frames, rather than only one, are provided with such a hinged arrangement. It has also been shown that the invention works best when the offset B is between approximately 0.5 and four inches (1 and 10 centimetres).

FIGS. 4-7 disclose in detail an alternative folding device, and this disclosed device is the folding device 10. It will be clear to the one skilled in the art, however, that the description is equally applicable to the folding device 11 which is a mirror image of the folding device 10. The folding device 10 incorporates a hinge pin 15 attached to the carrier body 6. The hinge pin consists of a U-shaped pin attached to the carrier body 6 in known manner by means of fasteners 16. The side frame 7 is provided with a hinge plate 17, which in the embodiment shown, consists of a U-shaped metal plate attached to the side frame 7 in known manner. The hinge plate is provided with an elongate hole 18 enclosing the hinge pin 15. The longitudinal direction (axis) of the elongate hole is indicated by the double arrow L and the longitudinal direction (axis) of the hinge pin by the double arrow T (see FIG. 6). The longitudinal part of the hinge pin is shown placed over the carrier body 6, but it will be clear to those persons skilled in the art that the part may be positioned offset to the carrier body in the same way as the hinge pin 14 described above with reference to FIGS. 8-9.

The function of the folding devices disclosed in FIGS. 4-7 will be described below in greater detail with reference to FIGS. 1-7. In the deployed position, the carrier body 6 and side frames 7 and 8 comprise a carrier frame 2 (FIG. 1). When the side frame 7 is folded inward, the frame is turned clockwise and the hinge plate 17 is pivoted about the hinge pin 15 in the manner illustrated in FIGS. 4-7. In the position in which the side frame is located at the end of the folding phase, the side frame can be moved sideways on the carrier body in the direction indicated by the arrow V in FIG. 2, the elongate hole 18 permitting the hinge plate 17 to move relative to the hinge pin 15. The side frame 8 is then folded in corresponding manner in the counter clockwise direction into the position shown in FIG. 3 and the side frame 8 is moved in the direction indicated by the arrow H in FIG. 3. The sideways movement of the side frames creates sufficient space on the carrier body 6 to permit the side frames to be folded without overlapping. Although both of the folding devices 10 and 11 are shown in the figures with elongate holes, it will be clear to one skilled in the art that only one of the folding devices 10 or 11 need to be provided with an elongate hole. In such case, however, the elongate hole must be made longer and tests have shown that the invention works best if each of the respective elongate holes is between 1 and 10 centimetres in length.

1. A load carrier (1) for transporting bicycles and which is mountable on a vehicle utilizing a coupling device (3), said load carrier comprising:
a carrier frame (2) having a loading surface (9) on which bicycles to be transported thereon are loadable and said carrier frame further comprising a carrier body (6) to which first and second side frames (7, 8) are attached in a foldable manner by folding devices (10, 11), said side frames, together with the carrier body, forming said carrier frame upon which front and rear wheels of a loaded bicycle are placed in a transporting configuration of said carrier frame (2); and
said side frames being foldable inward from an extended position in which said loading surface is presented to a folded position in which said side frames are positioned essentially over and on the carrier body; and
said folding device (10,11) for at least one of said side frames (7, 8) having a hinged arrangement (12) with a hinge pin (14) located at an offset distance (B) from a side (13) of the carrier body (6) facing said at least one side frame (7, 8).

2. The load carrier as recited in claim 1, wherein said offset distance (B) measures between approximately one-half inch and four inches.

3. The load carrier as recited in claim 1, wherein said folding device (10, 11) for at least one of the side frames (7, 8) includes a hinge pin (16) attached to the carrier body (6) and a hinge plate (17) attached to the side frame, said hinge plate being provided with an elongate hole (18) enclosing the hinge pin such that a longitudinal direction (L) of said hinge pin is lateral to a longitudinal direction (T) of said hinge pin and thereby permits the side frame to be moved sideways (V) to a position located over the carrier body.

4. The load carrier as recited in claim 3, wherein said elongate hole (18) measures between approximately one-half inch and four inches.

5. A load carrier (1) for transporting bicycles and which is mountable on a vehicle utilizing a coupling device (3), said load carrier comprising:
a carrier frame (2) having a carrier body (6) with first and second side frames (7, 8) foldably connected thereto by a pair of folding devices (10, 11), said carrier frame (2) being transitionable between a bicycle transporting configuration in which said first and second side frames (7, 8) are folded out into extended positions relative to said carrier body so that each side frame (7, 8) establishes a support platform for a respective one of a front and back wheel of a bicycle loaded on said carrier frame and a compact storable configuration in which said first and second side frames (7, 8) are inwardly folded over said carrier frame with respective distal ends of said first and second side frames (7, 8) adjacently positioned to one another.

6. The load carrier as recited in claim 5, wherein said carrier frame (2) has a width approximately equal to the width of said carrier body (6) when said carrier frame (2) is in said compact storable configuration.

7. The load carrier as recited in claim 5, wherein said carrier frame (2) has a width approximately equal to twice the width of said carrier body (6) when said carrier frame (2) is in said bicycle transporting configuration.

8. The load carrier as recited in claim 7, wherein said carrier frame (2) has a width approximately equal to the width of said carrier body (6) when said carrier frame (2) is in said compact storable configuration.

9. The load carrier as recited in claim 8, wherein each of said pair of folding devices (10, 11) includes a hinge pin (14) located at an offset distance (B) from a side (13) of the carrier body (6) facing the respective side frame (7, 8).

10. The load carrier as recited in claim 9, wherein said offset distance (B) measures between approximately one-half inch and four inches.

11. The load carrier as recited in claim 5, wherein each folding device (10, 11) includes a hinge pin (16) interconnected with the carrier body (6) and a hinge plate (17) interconnected with the respective side frame, said hinge plate being provided with an elongate hole (18) enclosing the hinge pin such that a longitudinal direction (T) of said hinge pin is lateral to a longitudinal direction (L) of said elongate hole (18) and thereby permits the side frame to be moved sideways (V) to a position located over the carrier body.

12. The load carrier as recited in claim 11, wherein said offset distance (B) measures between approximately one-half inch and four inches.
